(19) United States
(12) Patent Application Publication
(10) Pub. No.: US 2002/0049739 A1
(43) Pub. Date: Apr. 25, 2002

(54) Method and system for integrating online topical data with uniform user interface

(76) Inventor: Tony Hong, Diamond Bar, CA (US)

Correspondence Address: Tony Hong, 1548 Silver Lane, Diamond Bar, CA, 91765, US

(21) Appl. No.: 09/928,850

(22) Filed: Aug. 13, 2001

Related U.S. Application Data
(60) Provisional application No. 60/224,880, filed on Aug. 14, 2000.

(51) Int. Cl. G06F 7/00

(52) U.S. Cl. 707/1

(57) ABSTRACT

This invention generally relates to uniform user interface, and more particularly to method and system that provides an integrated common interface for all types of media and utilities that provides focused topical information, with related field of interests, and memory storage that remotely enables different available functions.

### BACKGROUND OF INVENTION

The growth of the online world has help bring information on demand in the real world much more accessible than before. The World Wide Web is now becoming more integrated to the daily activities of data creation, storage, and delivery. It has also evolved to improve data utilization efficiency to more fields than before. For example, one of the advantage of online data is that it can easily be requested, duplicated, transmitted, and displayed, and therefore reaching far greater distances and with faster speed than traditional data usage.

But even with the growth of the web and it's effective potential in the real world, it remain far from being efficiently integrated for optimal performance. That is, there are still no efficient method of offline data request and the subsequent delivery of online data available for all types of media and functioning utilities.

One of the problem with full integration of online and offline data is their differences of format, and their method of presentation. Online data, as intended from the beginning, serves to present plain textual or graphic displays on compatible browser. It is used mainly as a linear function, where requests for information lead to according responses. Offline data, on the other hand, operates with more non-linear functioning. Unlike the plain display of standard web content, offline media present content rich videos and audio that varies in styling and formats. Therefore, as a result, there are much more needs to request and utilize any available, relevant data from the web.

To better integrate the available data online with the consistent requests for relevant information offline, it is important to find a common interface that will serves as gateway to both worlds. Although there are many methods of performing this task, they remain inefficient on effectively integrating online data with offline request. For example, web addresses are used as simple gateways to online data from any offline interest on given topic. But this slow process provides limited content as result and small utilization of available data from request. Another form of information gateway relies on the use of personal digital assistants, and mobile computers. With the capacity to go online from remote location, these devices serve to access available online data regarding an interesting topic. However, with lack of common format, slow connection speed and disorganized results, these devices remain inefficient as simple data integrators. Another method to bridge the offline request and online database is the use of interactive links available on media such as televisions, which can lead to direct and more relevant online data. But these multimedia links are limited in terms of offline topic coverage and online data response. Since most of these links are commercially related, and the online data in return utilizes prearranged content, the use of these links did not serve as effective gateway of media and the online resources.

A simple, uniform user interface that focuses on direct online data integration with the different types of information and media in the real world will serves to bring greater efficiency and more utilization of any selected target topic.

### SUMMARY OF INVENTION

One of the main aspect of this simple, uniform user interface is to recognize that offline data requests revolve around any specific topic, and there are respective online data for that particular topic. By organizing the interface around the focus on individual topics, there are common links for informational requests and deliveries. Therefore, despite the complexity and non-linear nature of both the online world and the real world, there is a gateway of which it is counter directional in goals for both sides, namely one to request data and another to present data. It is important for the online data to be formatted in style that presents the potential coverage of web database while utilizing the multimedia resources of the display.

The advantages of data request initiated offline derive from its rich variety in available topics at any given situation. On the other hand, with online searches, the perimeters of interests are considerably smaller when confined to a specific type of web sites, such as news or sports sites. But online data, given its hierarchical arrangement of database, has its advantages when used with any targeted topic. Since information are filtered and categorized according to their field of interests, in standardized directories, any given topic of interest is related to its respective categories. Therefore, for any given requested and retrieved online topical information, there are in result the respective categories as well that is easily accessible.

Another aspect of a common user interface relies on the capability to move from one location to another location, with the utilization of mobile devices. Therefore, any given topic on demand at anywhere can fully utilize the available functions present at a given time. That is, with the use of topic memorization, any topic on request can participate with multimedia utilization for any given media or utility devices. For example, a topic can translates to a content rich video presentation on a television display, while the same topic on the interface memory can bring about processing analysis capacity on a computer. The use of memory storage of any given topic selected can bring better utilization of any available functioning of existing devices. The common user interface, with the topic request in memory, can invoke greater efficiency of available devices in that their respective functions can act together in a remote network stem from a common interface.

Drawings

### BRIEF DESCRIPTIONS OF THE DRAWINGS

FIG. 1 shows an embodiment of a uniform user interface that utilizes three functions, the directory, topic, and memory.

### DETAILED DESCRIPTIONS

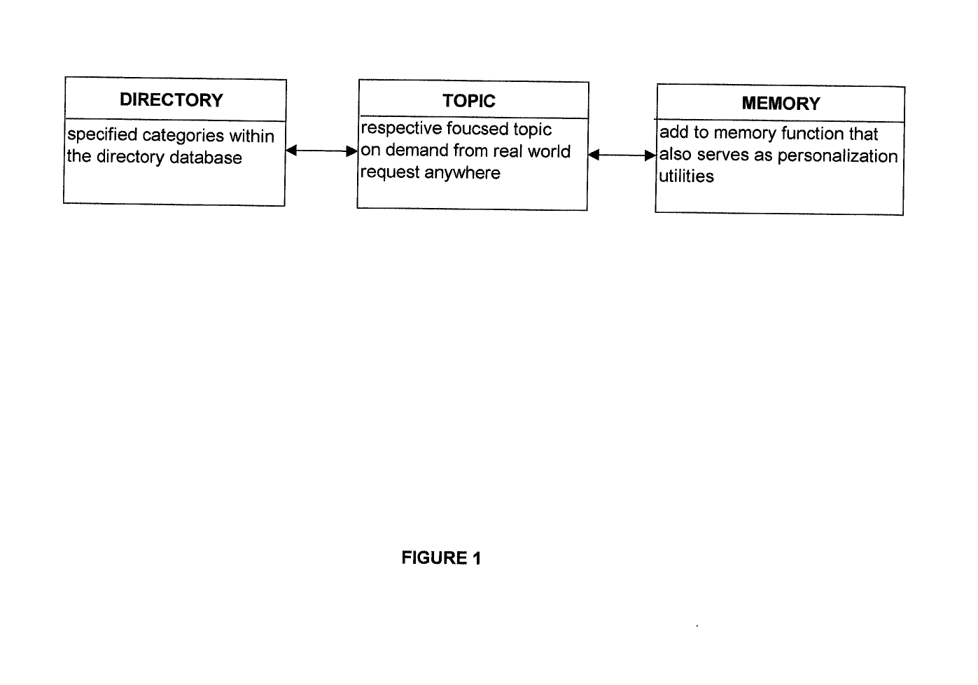

FIG. 1 illustrates the common interface that can be fully integrated by most media and utility devices with three main functional fields. The focus is the topic itself, with requests that can initiated anywhere and specifically formatted online data available in different media and scope of coverage relative to the particular device available. There's the directory, which identifies the general field of the selected topic and provides a simple path for wide range of related topics. Also, there's the memory, which serves as a backup function for the topic request. It can also be utilized as personalization tool. An aspect of the memory function is to bring topical request to different locations and different available devices, thereby integrating online data and information request with various types of media and utilities and their respective functions.

What I claim is:

1. In an online information platform with corresponding online topic data space emulating the offline world, a method for performing data collection, interpretation, and modification, said method comprising the steps of:
receiving a topic inquiry, wherein said topic inquiry having a plurality of field tags, comprising of structural directory information;
matching said field tags to a plurality of personalized topical fields, wherein said personalized topical fields comprising of predetermined topics;
locating a corresponding online topic data space with a predefined uniform user interface;
modifying said predefined uniform user interface, wherein said predefined uniform user interface comprising a directory field, a topic field, and a memory field; and
wherein a user can retrieve a focused topical data from said predefined uniform user interface.

2. The method of claim 1, further comprising the step of:
parsing the structural directory information according to a predefined directory hierarchy, whereby generating a list of topic elements;
caching said list of topic elements;
interpreting a list of selectable fields of interests from said topic elements; and
generating a list of corresponding topic selections to said topic field.

3. The method of claim 2, wherein said predefined directory hierarchy confines its data parameters to said corresponding online topic data space.

4. The method of claim 2, wherein said topic field modifies online topical data according to predefined fields of interests, in response to interpreting said list of corresponding topic selections.

5. The method of claim 1, further comprising the step of:
generating a new topical field in response to field tags with no matching personalized topical fields;
adding a new online topical data space;
linking said new online topical data space with corresponding data spaces; and
storing said new topical field to said memory field.

6. The method of claim 1, wherein said directory field displays said structural directory information according to a list of predefined fields of interests.

7. The method of claim 1, wherein said topic field displays said focused topical data according to said list of predefined fields of interests.

8. The method of claim 1, wherein said memory field stores said topic inquiry at said corresponding online topic data space, wherein said corresponding online topic data space organizes said uniform user interface;
wherein said corresponding online topic data space modifies said predefined directory hierarchy.

9. The method of claim 8, wherein the step of organizing said uniform user interface comprising the steps of:
identifying a list of corresponding multimedia subdirectory according to said predefined directory hierarchy;
processing said list of corresponding multimedia subdirectory at said topic field; and
loading a list of predefined media data prerequisites according to said list of corresponding multimedia subdirectory.

10. An online information platform with corresponding online topic data space emulating the offline world for performing data collection, interpretation, and modification, comprising:
means for receiving a topic inquiry, wherein said topic inquiry having a plurality of field tags, comprising of structural directory information;
means for matching said field tags to a plurality of personalized topical fields, wherein said personalized topical fields comprising of predetermined topics;
means for locating a corresponding online topic data space with a predefined uniform user interface;
means for modifying said predefined uniform user interface, wherein said predefined uniform user interface comprising a directory field, a topic field, and a memory field; and
means where a user can retrieve focused topical data from said predefined uniform user interface.

11. The online information platform of claim 10, wherein said online information platform further comprises:
means for parsing the structural directory information according to a predefined directory hierarchy, whereby generating a list of topic elements;
means for caching said list of topic elements;
means for interpreting a list of selectable fields of interests from said topic elements; and
means for generating a list of corresponding topic selections to said topic field.

12. The online information platform of claim 10, wherein said online information platform further comprises:
means for generating a new topical field in response to field tags with no matching personalized topical fields;
means for adding a new online topical data space;
means for linking said new online topical data space with corresponding data spaces; and
means for storing said new topical field to said memory field.
